(19) United States
(12) Patent Application Publication
(10) Pub. No.: US 2024/0095312 A1
(43) Pub. Date: Mar. 21, 2024

(54) SYSTEMS AND METHODS FOR 3D PRINTING OF LIMITED EDITION VIRTUAL ITEMS

(71) Applicant: DISH Network L.L.C., Englewood, CO (US)

(72) Inventors: Eric C. Pleiman, Englewood, CO (US); Jesus Flores Guerra, Englewood, CO (US)

(21) Appl. No.: 17/949,088

(22) Filed: Sep. 20, 2022

(51) Int. Cl. G06F 21/10; B29C 64/386; B33Y 50/00; G06F 21/44

(52) U.S. Cl. CPC G06F 21/10; B29C 64/386; B33Y 50/00; G06F 21/44; A63F 13/798; G06F 2221/0713

(57) ABSTRACT

A 3D printing system and method for limited edition virtual objects is disclosed. The method including: enabling a user to obtain a limited edition virtual object associated with an activity of the user in a virtual environment; receiving a request from the user to 3D print the limited edition virtual object; preparing a 3D printer file of the limited edition virtual object requested by the user; sending the 3D printer file of the limited edition virtual object to a 3D printer to be printed; and validating authenticity of transformation of the limited edition virtual object into a 3D printed tangible physical item.

### TECHNICAL FIELD

The present disclosure relates generally to a 3D printing system and method, and more particularly, but not exclusively, to a 3D printing system and method for printing virtual items.

### BACKGROUND

The proliferation of video games, as well as augmented and virtual reality environments appears to be growing at an ever increasing rate. These virtual gaming activities and virtual reality environment activities are extremely popular with both children and adults. Many of these video games and virtual activities enable users to collect or win virtual items, virtual awards, tournament awards, and badges, as well as acquired virtual clothing, gear, armor, and weapons for their avatar. Users play online games against other competitors in Xbox live, PlayStation live, Fortnite, and the like. Some of these games have tournaments weekly, monthly, or even daily. User of these games may achieve a virtual ranking or virtual trophies for being in the top 10, 5, 3, or 1.

### BRIEF SUMMARY

The present disclosure is directed towards a system for 3D printing of limited edition virtual objects to safeguard against loss by account hacking or computer storage failure. In some embodiments, the memory is arranged to store computer instructions, and the computer instructions are executable by the processor. Accordingly, the computer instructions cause the processor to: enable a user to obtain a limited edition virtual object associated with an activity of the user in a virtual environment; receive a request from the user to 3D print the limited edition virtual object; communicate with a server that stores the limited edition virtual object associated with the activity of a user in the virtual environment; prepare a 3D printer file of the limited edition virtual object requested by the user; prevent duplication of the 3D printer file of the limited edition virtual object requested by the user; send the 3D printer file of the limited edition virtual object to a 3D printer to be printed; and validate authenticity of transformation of the limited edition virtual object into a 3D printed tangible physical item.

In some embodiments of the system for 3D printing of limited edition virtual objects, duplication of the 3D printer file of the limited edition virtual object is prevented using digital rights management. In another aspect of some embodiments, the system further causes the processor to create a non-fungible token of the limited edition virtual object that is associated with the 3D printed tangible physical item. In still another aspect of some embodiments, the 3D printed tangible physical item is printed with a QR code that when scanned shows that current ownership of the non-fungible token associated with the 3D printed tangible physical item. In yet another aspect of some embodiments, the 3D printed tangible physical item is associated with time, place, and number sequence information.

In a further aspect of some embodiments, the 3D printer file of the limited edition virtual object is obtained as a result of an award or accomplishment in a virtual environment. In an additional aspect of some embodiments, the 3D printed tangible physical item is associated with a certificate. In still another aspect of some embodiments, the limited edition virtual object may only be printed once into a 3D printed tangible physical item.

In other embodiments, one or more methods for 3D printing of limited edition virtual objects to safeguard against account hacking and computer storage failure are disclosed. The method includes: enabling a user to obtain a limited edition virtual object associated with an activity of the user in a virtual environment; receiving a request from the user to 3D print the limited edition virtual object; communicate with a server that stores the limited edition virtual object associated with the activity of a user in the virtual environment; preparing a 3D printer file of the limited edition virtual object requested by the user; preventing duplication of the 3D printer file of the limited edition virtual object requested by the user; sending the 3D printer file of the limited edition virtual object to a 3D printer to be printed; and validating authenticity of transformation of the limited edition virtual object into a 3D printed tangible physical item.

In some embodiments of the method for 3D printing of limited edition virtual objects, preventing duplication of the 3D printer file of the limited edition virtual object further comprises employing digital rights management of the 3D printer file of the limited edition virtual object. In another aspect of some embodiments, the method further comprises creating a non-fungible token of the limited edition virtual object that is associated with the 3D printed tangible physical item. In still another aspect of some embodiments, the method further comprises: printing a QR code of the 3D printed tangible physical item; and displaying current ownership of the non-fungible token associated with the 3D printed tangible physical item when the QR code is scanned. In yet another aspect of some embodiments, the method further comprises associating one or more of time, place, or number sequence information with the 3D printed tangible physical item.

In a further aspect of some embodiments, the method further comprises obtaining the 3D printer file of the limited edition virtual object as a result of an award or accomplishment in a virtual environment. In an additional aspect of some embodiments, the method further comprises associating the 3D printed tangible physical item with a certificate. In still another aspect of some embodiments, the method further comprises restricting the limited edition virtual object to only be printable once into the 3D printed tangible physical item.

Additionally, in other embodiments, one or more non-transitory computer-readable storage mediums are disclosed. The one or more non-transitory computer-readable storage mediums have computer-executable instructions stored thereon that, when executed by at least one processor, cause the at least one processor to: enable a user to obtain a limited edition virtual object associated with an activity of the user in a virtual environment; receive a request from the user to 3D print the limited edition virtual object; communicate with a server that stores the limited edition virtual object associated with the activity of a user in the virtual environment; prepare a 3D printer file of the limited edition virtual object requested by the user; prevent duplication of the 3D printer file of the limited edition virtual object requested by the user; send the 3D printer file of the limited edition virtual object to a 3D printer to be printed; and validate authenticity of transformation of the limited edition virtual object into a 3D printed tangible physical item.

In another aspect of some embodiments, the non-transitory computer-readable storage medium further causes the processor to create a non-fungible token of the limited edition virtual object that is associated with the 3D printed tangible physical item. In still another aspect of some embodiments, the 3D printed tangible physical item is printed with a QR code that when scanned shows that current ownership of the non-fungible token associated with the 3D printed tangible physical item. In yet another aspect of some embodiments, the 3D printed tangible physical item is associated with time, place, and number sequence information.

Thus, the inventors have realized and solved the technological problem that since these are virtual objects, they are completely virtual with security and accessibility in the real world. Without the benefits taught herein, it is difficult for a user that has obtained one of these virtual items or achieved one of these virtual awards to interact with it outside of the game or secure the virtual item or virtual award against loss outside of the video game or other virtual environment.

Further, the inventors also realized that such virtual items or virtual awards may be lost forever if a user has their computer system hacked or otherwise compromised by a cyber-criminal. Additionally, the virtual items or virtual awards may be lost forever if a user simply has their computer crash and become unrecoverable. Finally, the virtual items or virtual awards may be lost forever if a user is banned from the gaming platform, the gaming company goes bankrupt, or the game otherwise ceases to be accessible to the user. The present disclosure solves the need to protect the user from these types of cyber risks due to both intentional actions of third parties, as well as simply technological failures of the computing components.

These features with other technological improvements, which will become subsequently apparent, reside in the details of construction and operation as more fully described hereafter and claimed, reference being had to the accompanying drawings forming a part hereof.

### BRIEF DESCRIPTION OF THE DRAWINGS

The present application will be more fully understood by reference to the following figures, which are for illustrative purposes only. The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

FIG. 1 illustrates an embodiment of a user engaging in an activity in a virtual environment 3D associated with a 3D printing system and method for limited edition virtual objects.

FIG. 2 illustrates an embodiment of a user finding a virtual item in a virtual environment 3D associated with a 3D printing system and method for limited edition virtual objects.

FIG. 3 illustrates a virtual trophy (e.g., a limited edition virtual object) acquired by a user from an activity in a virtual environment 3D associated with a 3D printing system and method for limited edition virtual objects.

FIG. 4 illustrates a user winning a tournament and a virtual award for first place in a virtual environment 3D associated with a 3D printing system and method for limited edition virtual objects.

FIG. 5 illustrates a perspective view of a 3D printing system to which a 3D printer file of the limited edition virtual object is sent to a 3D printer to be printed.

FIG. 6 illustrates a perspective view of 3D printing system that has printed the 3D printer file of the limited edition virtual object.

FIG. 7 illustrates a logic flow diagram for a method for 3D printing of limited edition virtual objects to safeguard against loss by account hacking.

FIG. 8 illustrates a system diagram that describes an example implementation of a computing system(s) for implementing embodiments described herein.

### DETAILED DESCRIPTION

Persons of ordinary skill in the art will understand that the present disclosure is illustrative only and not in any way limiting. Other embodiments and various combinations of the presently disclosed system and method readily suggest themselves to such skilled persons having the assistance of this disclosure.

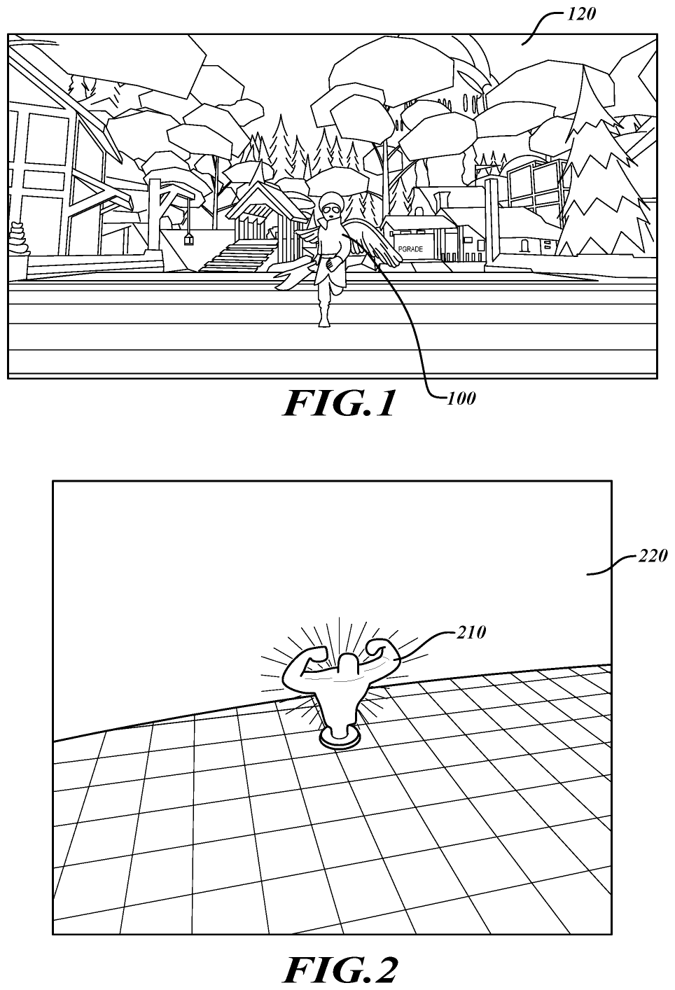

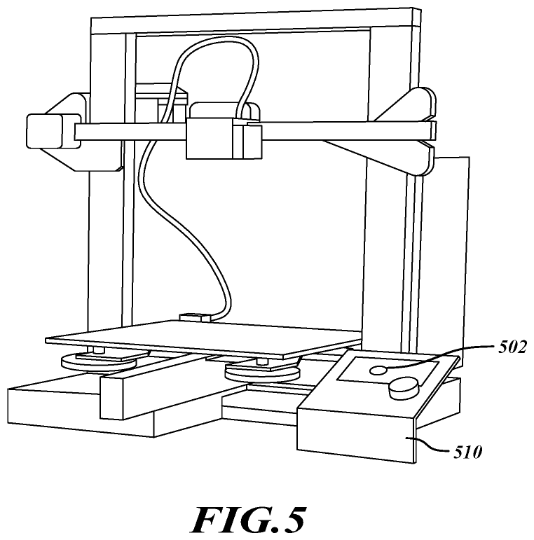

Each of the features and teachings disclosed herein can be utilized separately or in conjunction with other features and teachings to provide a 3D printing system and method for limited edition virtual objects. Representative examples utilizing many of these additional features and teachings, both separately and in combination, are described in further detail with reference to attached FIGS. 1-8. This detailed description is intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method. Also, other methods and systems may be used.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

When playing video games in virtual worlds, there are often unique and trendy virtual objects that may be obtained or awarded. These virtual objects range from miniature versions of cars to swords, footballs, and the like. Additionally, there are times in video games or other virtual environments, when a user receives a medallion after accomplishing a level or a task within the video game. In our examples, a user may be awarded a trophy for completing an entire virtual game or virtual quest. Notably, these achievements, medallions, medals, or trophies only exists virtually within the game. One technological problem created by such “virtual only” collections is that since these are virtual objects, they may be lost forever if a user has their computer system hacked, the user is banned from the gaming platform, the gaming company goes bankrupt, or the game otherwise ceased to be accessible to the user. The present disclosure is directed towards a technological solution to this technological problem with a 3D printing system and method for printing virtual items that enables a user to transform these virtual objects into tangible objects in the real world.

Some embodiments of the 3D printing system and method for printing virtual items enable a user to 3D print the trophy or medal and display it in their room or gaming room in real life (i.e., IRL). Thus, embodiments of the 3D printing system and method for printing virtual items enables the user to show off their accomplishments in real life, and not just in a virtual trophy room when the user is logged onto the respective gaming system. Additionally, when virtual items are printed with a 3D printing system, then the user can display awards, trophies, and medals from different video games and virtual environments all in the same place. In contrast, in traditional virtual environments, the user would only be able to see each virtual awards or accomplishment in the virtual game, platform, or environment to which it was native.

In some embodiments, a 3D printing system and method for limited edition virtual objects is employed in conjunction with a video game as shown in FIGS. 1-4. In such embodiments, the user is playing a video game on a system (e.g., Xbox, PlayStation, Nintendo switch, phone, tablet, or the like) that is remote from the central platform. In another aspect of some embodiments, the video game has an assigned server or database that includes different items as rewards within the game for different accomplishments, unique items, or completing the game.

Referring now to FIG. 1, a screenshot is shown of an embodiment of a user 100 engaging in an activity in a virtual environment 120. This activity may be a video game or video tournament in some embodiments. In other embodiments, this activity is a non-gaming activity in a virtual environment such as, by way of example only and not by way of limitation, a learning activity, a training activity, a virtual building activity, an educational activity, or an occupational activity.

As shown in FIG. 2, a screenshot is displayed of an embodiment in which a user finds a virtual item 210 in a virtual environment 220 associated with a 3D printing system and method for limited edition virtual objects. In some embodiments, finding this virtual item 210 is part of a video game and represents an award or accomplishment. In other embodiments, the virtual item 210 is part of a non-gaming virtual environment 220 and is not related to a gaming award, but nonetheless may represent some type of accomplishment.

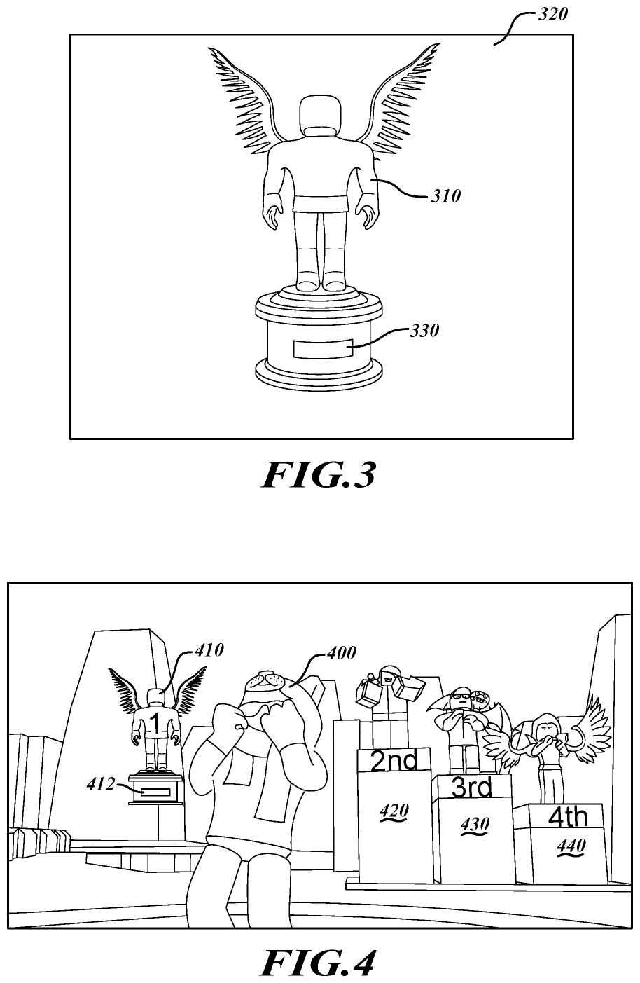

Referring now to FIG. 3, a screenshot is shown of an embodiment of a virtual trophy 310 (e.g., a limited edition virtual object) acquired by a user from a video game activity in a virtual environment 320 associated with a 3D printing system and method for limited edition virtual objects. In the past, a user was only able to acquire such a virtual trophy 310 and keep it in the virtual game environment 320. However, embodiments of the 3D printing system and method for limited edition virtual objects enable this type of virtual trophy 310 to be 3D printed and saved in the real world outside of the virtual environment 320 in which it was won. This enables the user to have an awards display in the real world that are secure from cyber-hackers that might steal or otherwise delete the virtual trophy 310 or other limited edition virtual objects. This also enables the user to have an awards display trophy cabinet in the real world that is protected from a computer system crash of the user's computer system. In some embodiments, date, time, name of the player, and other relevant information 330 related to the award or accomplishment by the user is shown on the virtual trophy 310.

As shown in FIG. 4, a screenshot is displayed of an embodiment of the 3D printing system and method for limited edition virtual objects in which a user 400 wins a tournament and a virtual award 410 for first place in a virtual tournament. In some such embodiments, the user is able to 3D print an award that includes a place (e.g., 1^{st} place 410, 2^{nd} place 420, 3^{rd} place 430, 4^{th} place 440, etc.) in the tournament, as well as potentially a date, time, and other relevant information 412 related to the tournament and the win by the user. All of this information 412 can be printed on the 3D printed physical version of the tournament award.

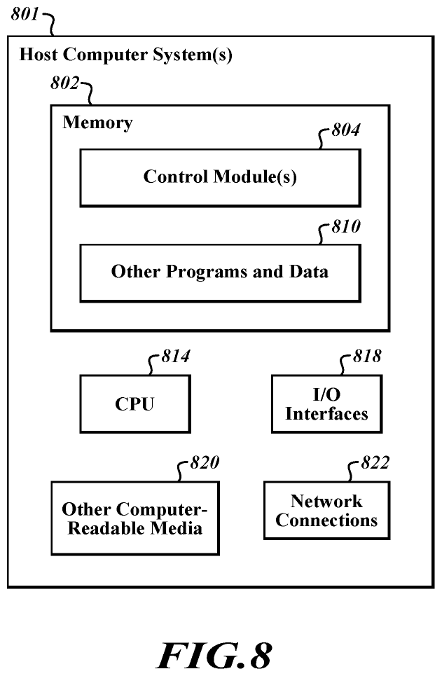

For video game tournaments, virtual trophies 410, 420, 430 may be awarded to players for 1^{st} place through 3^{rd} place in one or more embodiments. In one example, the participants are playing an online tournament with each other. When participants place 1^{st}, 2^{nd} or 3^{rd}, they are each awarded a virtual trophy 410, 420, 430. The game program then communicates with the server 801 (or host computing system as shown in FIG. 8) that is hosting the tournament and requests that a 3D print file be sent for the virtual trophy that was won, potentially with the date, time, and name of the tournament to be printed on trophy in some embodiments. The 3D print file is then used by a 3D printer to print the real world 3D printed trophy from a virtual accomplishment for the user in real life.

In another aspect of the 3D printing system and method, medals, trophies, and other virtual items to be printed are virtually produced in a number of limited runs or batches, such as it is done with wine releases, rare books, and the like, e.g., 1/1, 5/5, 10/10, 100/100, or 250/250. Thus in such embodiments, there are only 1, 5, 10, 100, or 250 of these virtual items that may be potentially printed and owned in the real world.

Referring now to FIGS. 3, 5, 6, and 8, an embodiment of a 3D printing system is shown in which a 3D printer file 502 of the limited edition virtual object 310 is sent to a 3D printer 510 to be printed. The system for 3D printing of limited edition virtual objects may be used to safeguard against loss by account hacking or computer storage failure. In some embodiments, the computer system 801 includes a processor 814 and a memory 802 that is arranged to store computer instructions. The computer instructions are executable by the processor 814. In some embodiments, the computer instructions cause the processor 814 to enable a user to obtain a limited edition virtual object 310 associated with an activity of the user in a virtual environment. Additionally, the system is configured to receive a request from the user to 3D print the limited edition virtual object 310. Further, the system is configured to communicate with a server that stores the limited edition virtual object 310 associated with the activity of a user in the virtual environment. The system then prepares a 3D printer file 502 of the limited edition virtual object 310 requested by the user. Notably, the system employs technology, such as digital rights management, to prevent duplication of the 3D printer file 502 of the limited edition virtual object 310 requested by the user.

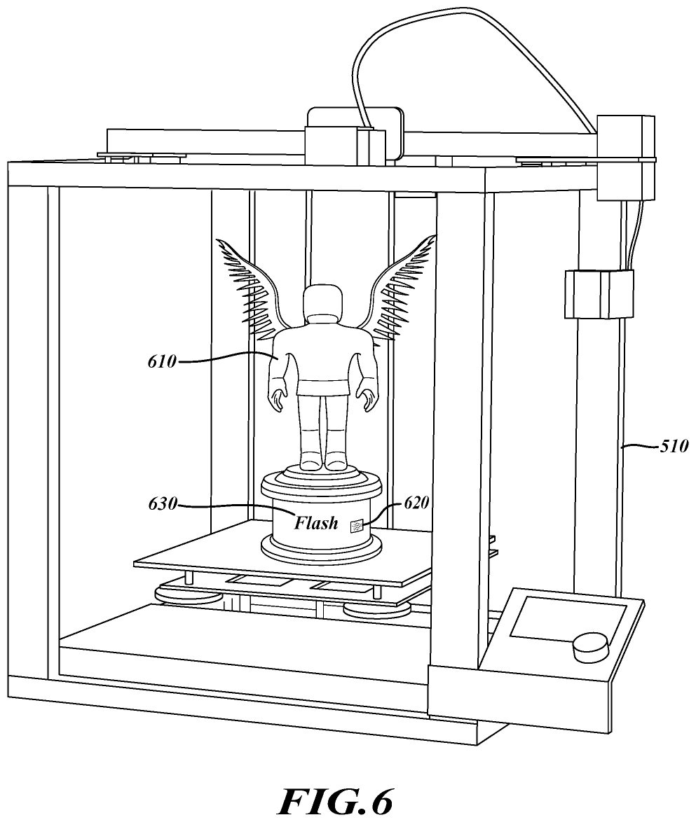

In some embodiments, the system sends the 3D printer file 502 of the limited edition virtual object 310 to a 3D printer 510 to be printed. In a subset of those embodiments, the system sends the 3D printer file 502 of the limited edition virtual object 310 to a 3D printer 510 that is part of the same system to be printed. In another subset of those embodiments, the system sends the 3D printer file 502 of the limited edition virtual object 310 to a 3D printer 510 that is part of a third party system to be printed. In still another subset of those embodiments, the system sends the 3D printer file 502 of the limited edition virtual object 310 to a 3D printer 510 that is owned by the user to be printed. As shown in FIG. 6, in one embodiment the 3D printing system has printed a 3D printed tangible physical item 610 from the 3D printer file of the limited edition virtual object 310, regardless of the location or the ownership of the 3D printer.

Moreover, in some embodiments of the 3D printing system and method for limited edition virtual objects, the system validates the authenticity of transformation of the limited edition virtual object 310 into the 3D printed tangible physical item 610. In some such embodiments, the system validates the authenticity of transformation by creating a non-fungible token of the limited edition virtual object 310 that is associated with the 3D printed tangible physical item 610. Non-fungible tokens are blockchain-based tokens each representing a unique asset such as digital content or artwork. A non-fungible token is a digital certificate of ownership and authenticity for a specific asset. Non-fungible tokens are cryptographically verifiable as well as easily transferable. Additionally, the origin and the current owner of the asset can be readily determined by leveraging cryptographic signatures that are native to the blockchain.

Additionally, in another aspect of some embodiments, the limited edition virtual objects 310 are tradeable as non-fungible tokens that specify if there are any 3D prints of the virtual item still available or if the non-fungible token is now only a virtual non-fungible token. Once traded in the marketplace, the non-fungible token then appears in the new owner's “trophy” room with or without the real world 3D printability associated with it, in some embodiments of the 3D printing system and method.

In still another aspect of some embodiments, the 3D printed tangible physical item 610 is printed with a bar code 620, such as a QR code, any of type of bar code, whether a matrix bar code, a one, two or three dimensional bar code, or other unique code that when scanned shows the current ownership of the non-fungible token associated with the 3D printed tangible physical item 610 as well as provides a link to the details of the game in which the award was won, including providing access to a recording of or showing a replay of the game. Thus, the term, bar code or QR code is used herein in the broadest sense to include any of these computer readable codes that are printed, displayed, shown on a screen or the like.

In some embodiments, the scanned bar code 620, whether a QR code 620 or other type of code provides a link or contacts to the server for that game's virtual items and their non-fungible tokens. The system then locates the username and enables the user that scanned the 3D printed physical item's QR code 620 to contact the owner of the non-fungible token on the non-fungible token marketplace and to purchase the non-fungible token associated with the 3D printed physical item 610.

In addition to having the option for a QR code 620 to be printed on the 3D printed physical item 610, in another aspect of some embodiments, the name of the player that accomplished the task (or found the item, or the like) is inserted into the 3D print file 502 so their name is printed on the physical item. Alternatively or additionally, the username is added into the non-fungible token so the item has the serial number along with the user that originally obtained the virtual item being displayed digitally. In such an embodiment, even if the non-fungible token is traded or sold in the marketplace, the non-fungible token may still be found within the server with a username search to see all of the non-fungible tokens obtained over a time period.

In yet another aspect of some embodiments, the 3D printed tangible physical item 610 can have printed thereon details associated with time, place, name of the player, ranking in the game, and number sequence information 630 that is printed on the 3D printed tangible physical item 610. In another aspect of some embodiments, the system validates the authenticity of transformation by associating the 3D printed tangible physical item 610 with a physical certificate. Notably, in some embodiments, the limited edition virtual object is limited to be only printable once into a 3D printed tangible physical item 610. In other embodiments, the limited edition virtual object is only printable a specific number of times into a 3D printed tangible physical item 610 other than one (e.g., two, five, ten, or the like).

The 3D printing system and method for limited edition virtual objects is not limited only to medals and trophies within games, it may also be used in conjunction with non-gaming virtual activities, such as virtual car racing and collecting. For example, a user that plays a driving or car video game and completed the tasks needed to obtain an F-1, a 911 Porsche, or Lamborghini within the virtual environment, may have a car room or garage instead of a Trophy room. Within that room, the virtual Porsche, F-1, or Lamborghini car would have the completion number assigned to it from the game server. In some embodiments, this completion number is printable on the car by the 3D printing system and method for limited edition virtual objects. In one or more embodiments, the user has the option to print the serial number under the car, on the roof, trunk, doors, or the hood. This 3D printing of the virtual car collection enables the user to have a shelf in the real world proudly displaying the serial-numbered cars that signify the user's accomplishments. In some embodiments, different scaled models are available for different accomplishments: 1^{st} place equals a 1/16^{th} scale model, 2^{nd} place through 5^{th} place equals a 1/32^{nd}, and the like. Alternatively, in other embodiments, all car models are printed at the same scaled size with just the serial number being different.

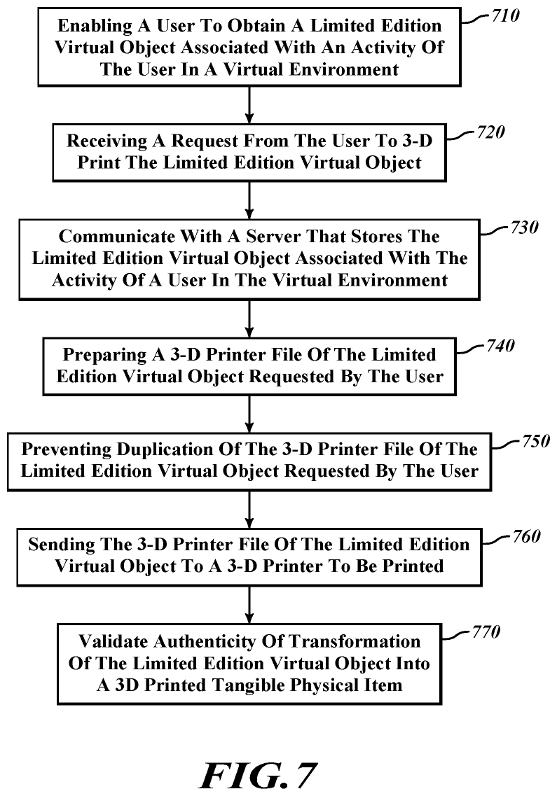

FIG. 7 is a logic diagram showing a 3D printing system and method for limited edition virtual objects. As shown in FIGS. 3 and 5-8, at operation 710, the method includes enabling a user to obtain a limited edition virtual object 310 associated with an activity of the user in a virtual environment 320. At operation 720, the method includes receiving a request from the user to 3D print the limited edition virtual object 310. At operation 730, the method includes communicating with a server 801 that stores the limited edition virtual object 310 associated with the activity of a user in the virtual environment 320. At operation 740, the method includes communicating with a server 801 that stores the limited edition virtual object 310 associated with the activity of a user in the virtual environment 320. At operation 750, the method includes preventing duplication of the 3D printer file 502 of the limited edition virtual object 310 requested by the user. At operation 760, the method includes sending the 3D printer file 502 of the limited edition virtual object 310 to a 3D printer 510 to be 3D printed. At operation 770, the method includes validating authenticity of transformation of the limited edition virtual object 310 into a 3D printed tangible physical item 610.

Referring again to FIG. 8, when the user completes the first level of the game in one such embodiment, the game recognizes the completion of level 1, and provides the user a virtual medal on the screen to put in a trophy room of the video game. This level 1 medal may have a time stamp of the time and date that the user accomplished level 1. In some embodiments, the video game supported by the gaming system connects with the server 801 using a wired connection, while in other embodiments, the game supported by the gaming system connects with the server 801 using wireless connection. The server 801 logs the data and time that the user completes level 1. The database assigns the level 1 medal and a serial number to the user's virtual level 1 medal based upon the number of people that completed level 1 prior to this user. If zero people completed level 1 prior to this user, then the user obtains serial number #0001 assigned to his medal. In contrast, if 24 people had completed level 1 prior to the user completing level 1, the user's medal would be assigned #25 by the database/server.

In some embodiments, the 3D print file 502 is downloaded from a user's trophy room or a general game's trophy room and the 3D print file of the virtual trophy (or other limited edition virtual object) is sent to a 3D printer 510 to be printed. As described above, in some embodiments, Digital Rights Management or other security methods are employed to the 3D print files 502 so the trophies or medals are only able to be printed a limited number of times. In this manner, the uniqueness and scarcity of the trophies is reserved due to the limit on the #1 medals that are possible to be displayed by users in the physical world. Thus, the 3D printed trophies have integrity and uniqueness. As described above, users are not able to share the 3D print files with each other. Typically, the 3D print file prints only once. However, in some embodiments, after the print count is completed, the 3D print file disappears (e.g., self-deletes) in accordance with the settings of the video game.

FIG. 8 shows a system diagram that describes an example implementation of a computing system(s) for implementing embodiments described herein. The functionality described herein for a 3D printing system and method for limited edition virtual objects, can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that it is agnostic to the underlying cloud infrastructure, allowing higher deployment agility and flexibility.

In particular, shown is an example server or host computer system(s) 801. In some embodiments, one or more special-purpose computing systems may be used to implement the functionality described herein. Accordingly, various embodiments described herein may be implemented in software, hardware, firmware, or in some combination thereof. Host computer system(s) 801 may include memory 802, one or more central processing units (CPUs) 814, I/O interfaces 818, other computer-readable media 820, and network connections 822.

Memory 802 may include one or more various types of non-volatile and/or volatile storage technologies. Examples of memory 802 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 802 may be utilized to store information, including computer-readable instructions that are utilized by CPU 814 to perform actions, including those of embodiments described herein.

Memory 802 may have stored thereon control module(s) 804. The control module(s) 804 may be configured to implement and/or perform some or all of the functions of the systems, components and modules described herein for a 3D printing system and method for limited edition virtual objects. Memory 802 may also store other programs and data 810, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, etc.

Network connections 822 are configured to communicate with other computing devices to facilitate the functionality described herein. In various embodiments, the network connections 822 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 818 may include a video interface, other data input or output interfaces, or the like. Other computer-readable media 820 may include other types of stationary or removable computer-readable media, such as removable flash drives, external hard drives, or the like.

Some methods, functions, steps, or features have been described as being executed by corresponding software by a processor. It is understood that any methods, functions, steps, features, or anything related to the systems disclosed herein may be implemented by hardware, software (e.g., firmware), or circuits despite certain methods, functions, steps, or features having been described herein with reference to software corresponding thereto that is executable by a processor to achieve the desired method, function, or step. It is understood that software instructions may reside on a non-transitory medium such as one or more memories accessible to one or more processors in the systems disclosed herein. For example, where a computing device receives data, it is understood that the computing device processes that data whether processing the data is affirmatively stated or not. Processing the data may include storing the received data, analyzing the received data, and/or processing the data to achieve the desired result, function, method, or step. It is further understood that input data from one computing device or system may be considered output data from another computing device or system, and vice versa. It is yet further understood that any methods, functions, steps, features, results, or anything related to the systems disclosed herein may be represented by data that may be stored on one or more memories, processed by one or more computing devices, received by one or more computing devices, transmitted by one or more computing devices, and the like.

The foregoing description, for purposes of explanation, uses specific nomenclature and formula to provide a thorough understanding of the disclosed embodiments. It should be apparent to those of skill in the art that the specific details are not required in order to practice the disclosure. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the disclosure to the precise forms disclosed, and those of skill in the art recognize that many modifications and variations are possible in view of the above teachings.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above described exemplary embodiments, but should be defined only in accordance with the following claims and their equivalents.

1. A system comprising:
a memory arranged to store computer instructions, the computer instructions executable by a processor that cause the processor to:
enable a user to obtain a limited edition virtual object associated with an activity of the user in a virtual environment;
receive a request from the user to 3D print the limited edition virtual object;
communicate with a server that stores the limited edition virtual object associated with the activity of a user in the virtual environment;
prepare a 3D printer file of the limited edition virtual object requested by the user;
prevent duplication of the 3D printer file of the limited edition virtual object requested by the user;
send the 3D printer file of the limited edition virtual object to a 3D printer to be printed; and
validate authenticity of transformation of the limited edition virtual object into a 3D printed tangible physical item.

2. The system of claim 1, wherein duplication of the 3D printer file of the limited edition virtual object is prevented using digital rights management.

3. The system of claim 1, wherein the system validates authenticity of transformation by causing the processor to create a non-fungible token of the limited edition virtual object that is associated with the 3D printed tangible physical item.

4. The system of claim 3, wherein the 3D printed tangible physical item is printed with a bar code that when scanned shows that current ownership of the non-fungible token associated with the 3D printed tangible physical item.

5. The system of claim 1, wherein the system validates authenticity of transformation by associating the 3D printed tangible physical item with one or more of time, place, and number sequence information.

6. The system of claim 1, wherein the 3D printer file of the limited edition virtual object is obtained as a result of an award or accomplishment in a virtual environment.

7. The system of claim 1, wherein the system validates authenticity of transformation by associating the 3D printed tangible physical item with a certificate.

8. The system of claim 1, wherein the limited edition virtual object may only be printed once into a 3D printed tangible physical item.

9. A method comprising:
enabling a user to obtain a limited edition virtual object associated with an activity of the user in a virtual environment;
receiving a request from the user to 3D print the limited edition virtual object;
communicating with a server that stores the limited edition virtual object associated with the activity of a user in the virtual environment;
preparing a 3D printer file of the limited edition virtual object requested by the user;
preventing duplication of the 3D printer file of the limited edition virtual object requested by the user;
sending the 3D printer file of the limited edition virtual object to a 3D printer to be printed; and
validating authenticity of transformation of the limited edition virtual object into a 3D printed tangible physical item.

10. The method of claim 9, wherein preventing duplication of the 3D printer file of the limited edition virtual object further comprises employing digital rights management of the 3D printer file of the limited edition virtual object.

11. The method of claim 9, further comprising creating a non-fungible token of the limited edition virtual object that is associated with the 3D printed tangible physical item.

12. The method of claim 11, further comprising:
printing a bar code of the 3D printed tangible physical item; and
displaying current ownership of the non-fungible token associated with the 3D printed tangible physical item when the QR code is scanned.

13. The method of claim 9, further comprising associating one or more of time, place, or number sequence information with the 3D printed tangible physical item.

14. The method of claim 9, further comprising obtaining the 3D printer file of the limited edition virtual object as a result of an award or accomplishment in a virtual environment.

15. The method of claim 9, wherein validating authenticity of transformation further comprises associating the 3D printed tangible physical item with a certificate.

16. The method of claim 9, further comprising restricting the limited edition virtual object to only be printable once into the 3D printed tangible physical item.

17. A non-transitory computer-readable storage medium having computer-executable instructions stored thereon that, when executed by at least one processor, cause the at least one processor to cause actions to be performed, the actions including:
enable a user to obtain a limited edition virtual object associated with an activity of the user in a virtual environment;
receive a request from the user to 3D print the limited edition virtual object;
communicate with a server that stores the limited edition virtual object associated with the activity of a user in the virtual environment;
prepare a 3D printer file of the limited edition virtual object requested by the user;
prevent duplication of the 3D printer file of the limited edition virtual object requested by the user;
send the 3D printer file of the limited edition virtual object to a 3D printer to be printed; and
validate authenticity of transformation of the limited edition virtual object into a 3D printed tangible physical item.

18. The non-transitory computer-readable storage medium of claim 17, wherein the non-transitory computer-readable storage medium further causes the processor to create a non-fungible token of the limited edition virtual object that is associated with the 3D printed tangible physical item.

19. The non-transitory computer-readable storage medium of claim 18, wherein the 3D printed tangible physical item is printed with a QR code that when scanned shows that current ownership of the non-fungible token associated with the 3D printed tangible physical item.

20. The non-transitory computer-readable storage medium of claim 17, wherein the non-transitory computer-readable storage medium validates authenticity of transformation by associating the 3D printed tangible physical item with one or more of time, place, and number sequence information.
